(19) United States
(12) Patent Application Publication
(10) Pub. No.: US 2014/0012891 A1
(43) Pub. Date: Jan. 9, 2014

(54) COLLABORATIVE SOCIAL NETWORK PLATFORM

(71) Applicant: William Wong, Hong Kong (CN)

(72) Inventor: William Wong, Hong Kong (CN)

(21) Appl. No.: 13/540,838

(22) Filed: Jul. 3, 2012

(51) Int. Cl. G06F 15/16

(52) U.S. Cl. 709/203; 709/204

(57) ABSTRACT

The present disclosure provides a method and system for creating an ecosystem of application developers and advertisers in the context of a game. This platform enables a collaborative social network that allows application developers to enhance a game experience. This platform comprises: a database operable to store data associated with a plurality of social network members; a host application server operable to access data from the database and control a multiplayer online poker game; and an application server operable to control the one or more third party applications and operable to access data from the database. A display associated with the multiplayer online poker game may include an area reserved for one or more third party applications. The rate at which the application server accesses data may be controlled by the host application server

### CROSS-REFERENCE TO RELATED APPLICATIONS/INCORPORATION BY REFERENCE

Not Applicable

### FIELD

Certain embodiments of the disclosure relate to an open platform within a game in a social network environment. More specifically, certain embodiments of the disclosure relate to a method and system for multiple developers to collaborate and contribute to the experience of playing the game.

### BACKGROUND

Social networks have changed the way people communicate and interact. As the number of social networks has grown, significant efforts exist with regard to enhancing communication and interaction. Applications and services exist that allow a user to play games with others online. However, the development capabilities of such social network gaming services are limited by their resources.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method are provided for a collaborative social network platform substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system for a collaborative social network platform, in accordance with an embodiment of the disclosure.

FIG. 2 is a flow diagram of an exemplary method for third-party application approval for a collaborative social network platform, in accordance with an embodiment of the disclosure.

FIG. 3a is a diagram of an exemplary core poker client for a collaborative social network platform, in accordance with an embodiment of the disclosure.

FIG. 3b is a diagram of an exemplary authentication module for a collaborative social network platform, in accordance with an embodiment of the disclosure.

FIG. 3c is a diagram of an exemplary interface between the core poker client and the authentication module in a collaborative social network platform, in accordance with an embodiment of the disclosure.

FIG. 4a and FIG. 4b illustrate an exemplary flow chart of a backend for a collaborative social network platform, in accordance with an embodiment of the disclosure.

FIG. 5 is a diagram of an exemplary client display for a collaborative social network platform, in accordance with an embodiment of the disclosure.

FIG. 6 is an exemplary illustration of using an area for interaction under third party control, in accordance with an embodiment of the disclosure.

FIG. 7 is another exemplary illustration of using an area for interaction under third party control, in accordance with an embodiment of the disclosure.

### DETAILED DESCRIPTION

Certain embodiments of this invention relate to a multiplayer online poker game within this open platform that allows third party application developers to enhance the experience of the poker players. In other embodiments, a poker room can be used as a dating game environment, where “rules” of the dating game include rewarding levels of social interaction with poker chips for use in the multiplayer online poker game.

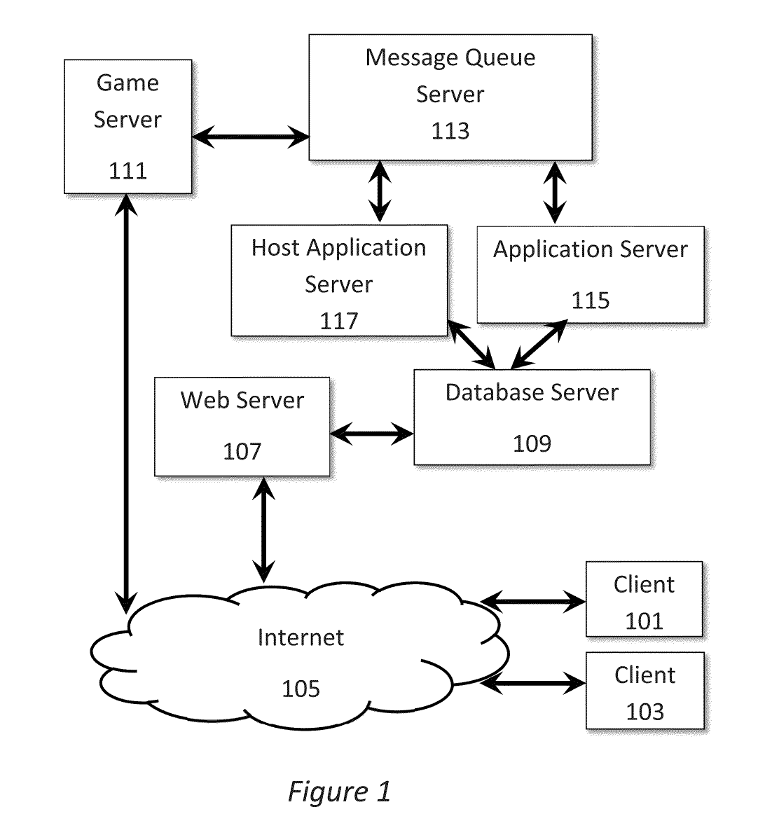

FIG. 1 is a block diagram of an exemplary system for a collaborative social network platform. The social network platform comprises clients 101 and 103, a connection to the internet 105, a web server 107, a database server 109, a game server 111, a message queue server 113, an application server 115, and a host application server 117. A server in this disclosure is a computer program running to serve the requests of other programs. The “backend” of this platform comprises the database server 109, the message queue server 113, the application server 15, and the host application server 117.

The game server 111 is a stateful socket-server that maintains a live direct connection with the game of the player at a client 101 or 103. The data queue 113 receives messages or other data from various servers, such as the game sever 111 and application server 115. The message queue server 113 may be implemented as a data queue in the backend configuration. The application server 115 loads, saves and mutates data to and from the database 109. For example, the application server 115 may load and save profiles, scores and inventories. The host application server 117 controls the game that forms the development platform. For example in an online poker game, the host application 117 acts as a poker logic server and deals cards in the poker game, controls the playing order, and calculates the winning poker-hands. The database server 109 stores all results.

Third parties may be given access to information in the database 109, on a limited basis, to develop their own applications. The web server 107 handles all non-real-time requests of the game client and requests for files like the game itself, images, code etc . . . The game client 101 or 103 makes two connections to be able to play the game; one direct connection to the game server for real-time bi-directional data and one pull-request for each demand for a file or other non-critical data.

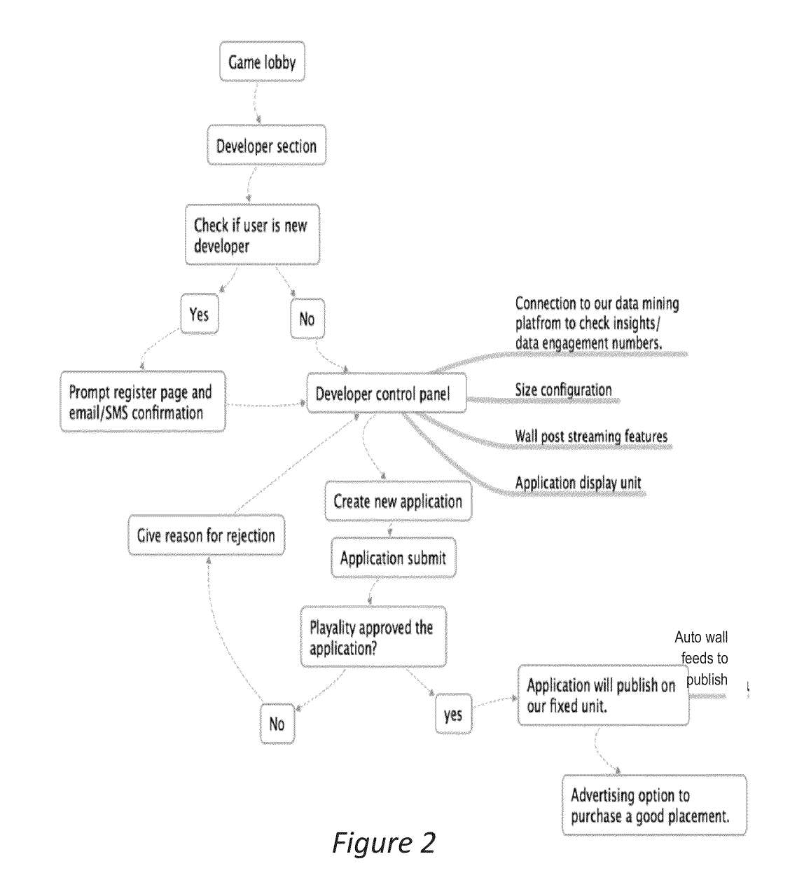

FIG. 2 is a flow diagram of an exemplary method for third-party application approval for a collaborative social network platform. Prior to being published, third-party applications must be authorized. From the game lobby, a third-party developer will enter the developer section. If the third-party developer has not registered, the developer will be prompted to do so. A guide on how to develop apps for the platform is made available. A developer control panel enables the third-party application developer to select what information they require from the database. When an application for review has been submitted and approved, an encrypted certification id will be assigned to the application to enable publishing.

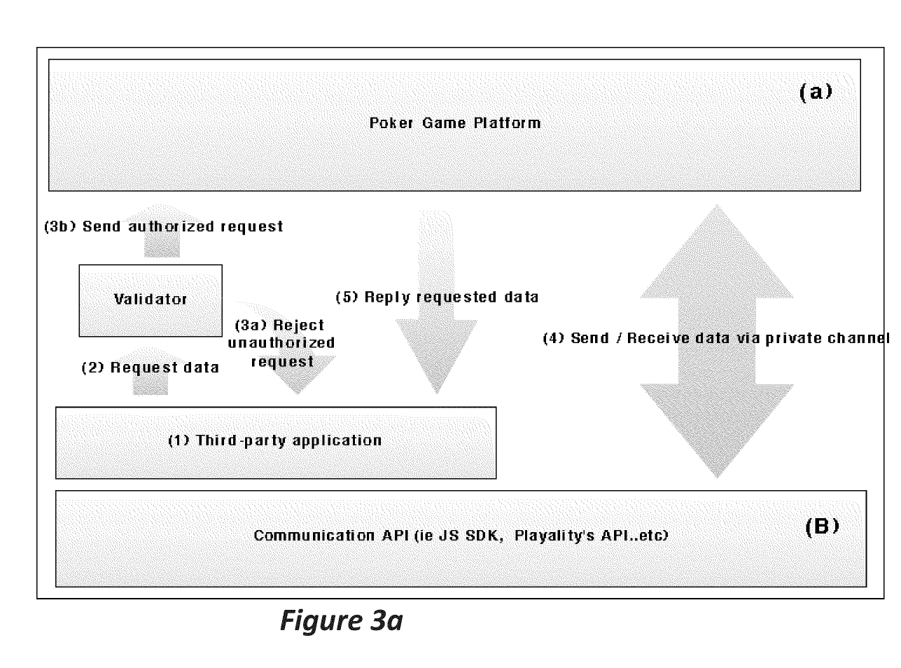

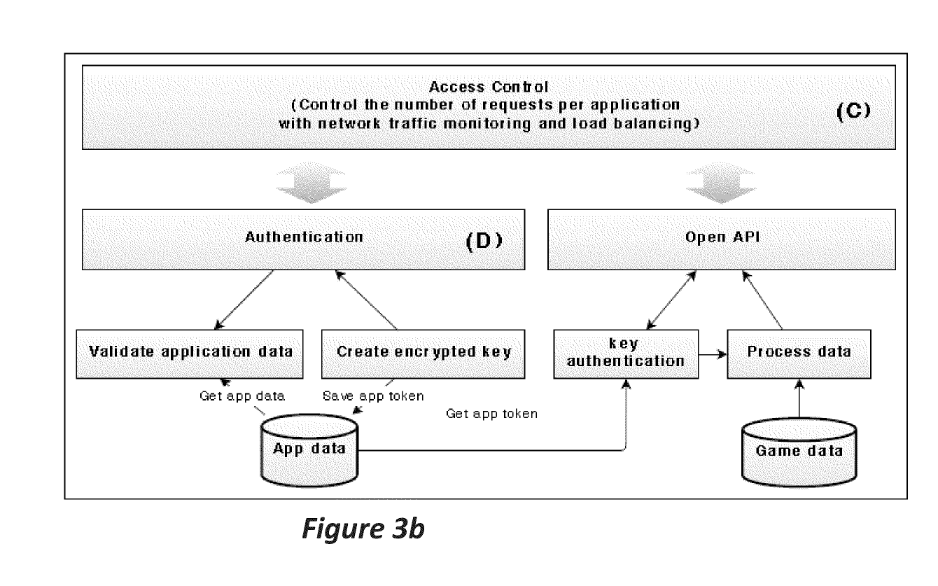

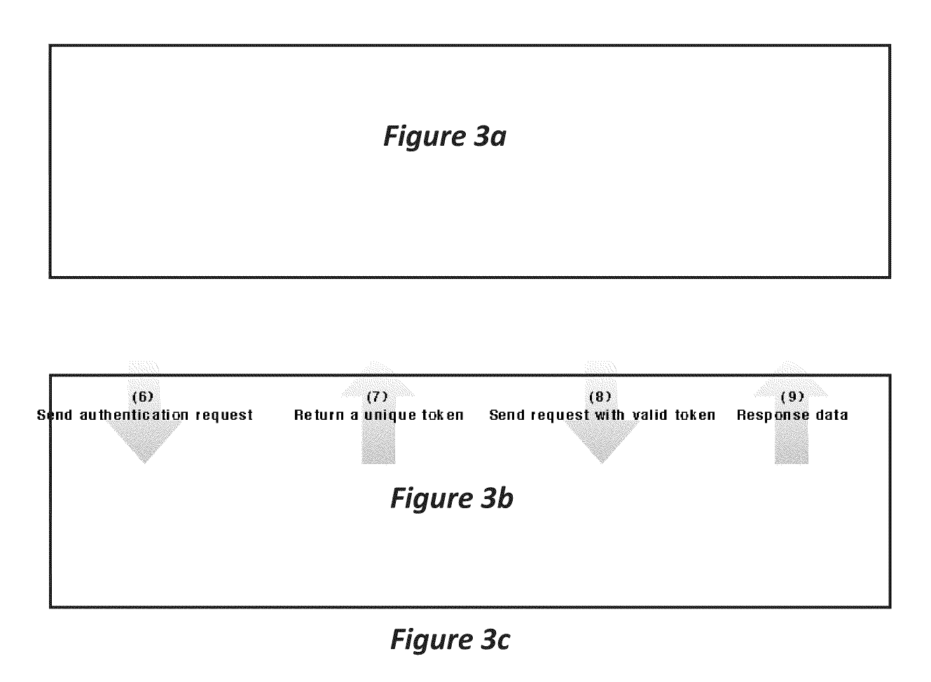

FIG. 3a is a diagram of an exemplary core poker client for a collaborative social network platform. The core poker client will have an integrated fixed area as an output device. The poker application platform (a) will support every front-end language. (Flash, HTML5, JS, Unity, etc . . . ). The poker client communicates with an API (B) for integration and data gathering via a private channel (4). In the case of poorly designed application which send high amount of request to our system. The bandwidth load-balancing control will actively limit the amount of bandwidth per application. A third-party application (1) will request data (2) from a validator. If the request is unauthorized, the request is rejected (3a). An authorized request is sent (3b) to the poker game platform (a), and the poker game platform (a) replies with the requested data.

FIG. 3b is a diagram of an exemplary authentication module for a collaborative social network platform. The authentication module controls the developers' identification processes. The module will perform a security audit, email confirmation, and validate applications before issuing encrypted secret keys to developers. The open standard backend communication also works as a security system. Only known functions can be called by the iframe, all others will be ignored. If the application in the iframe makes too many errors (on purpose or not) then the requests will be ignored for a predetermined time. The open standard backend communication works as a watchdog. If the calling application makes too many requests, the executing of those requests will be throttled. This prevents that too many requests (on purpose or by accident due to bad designed source code) being sent to the backend servers.

FIG. 3c is a diagram of an exemplary interface between the core poker client and the authentication module in a collaborative social network platform, in accordance with an embodiment of the disclosure. Through the API, the client can send an authentication request to the authentication module (6). The authentication module can return a unique token (7). Through the API, the client can then send a request with a valid token (8) and receive response data (9) from the authentication module.

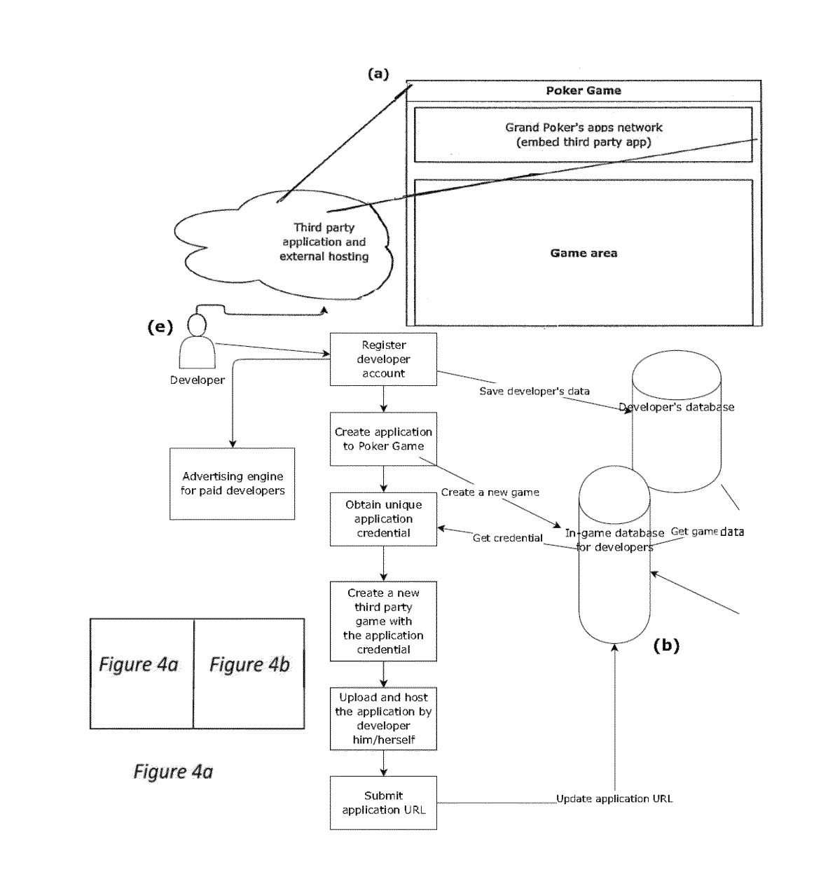

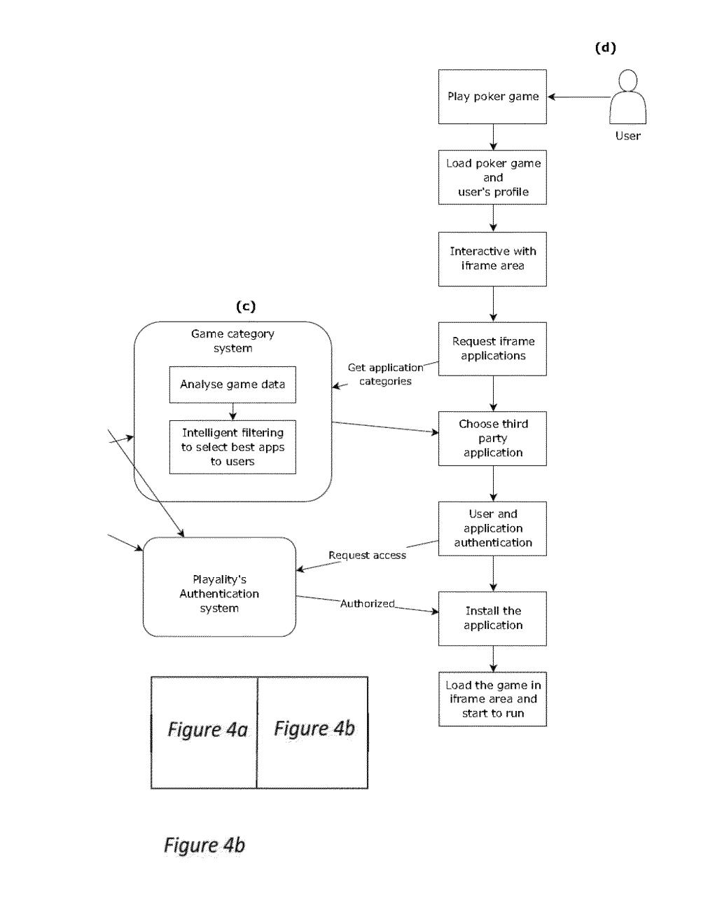

FIG. 4a and FIG. 4b illustrate an exemplary flow chart of a backend for a collaborative social network platform. The poker display contains a fixed area for the output of third party application (a). The third-party applications may access an in-game database (b). The database system allows players to query user's profile, game data and other information. The backend server will sort, by category, an application's popularity and a player's installed apps. When a third-party application is published, it will be categorized (c) to determine an order for displaying the associated icon in the area for third-party applications. Action and a co-efficient of growth are used to rank applications. Once published, the third-party application can be used by a player of the online poker game (d).

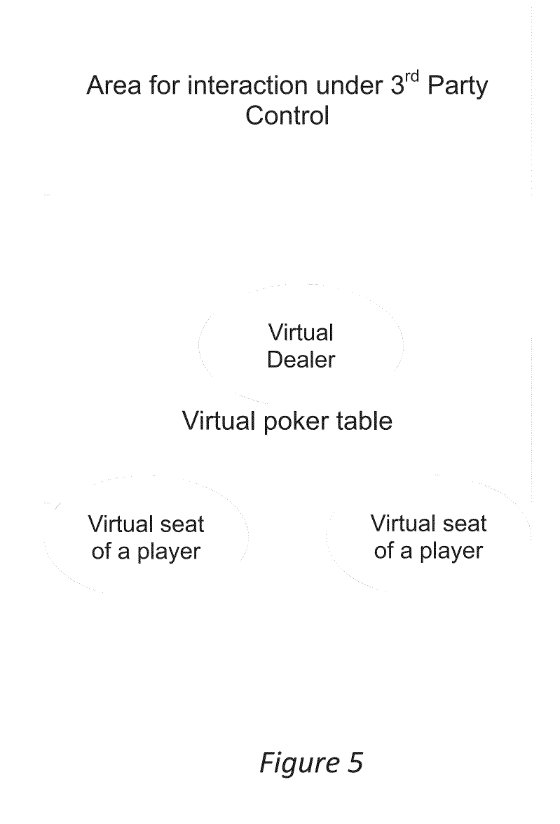

FIG. 5 is a diagram of an exemplary client display for a collaborative social network platform. The elements of a display may include a virtual poker table, a virtual dealer, and virtual seats for players. The display also includes an area for interaction under third party control. In a given online (internet) game, playable through an internet browser (e.g. Firefox, Internet Explorer, Safari, Chrome etc . . . ), a separate area in the game, well visible for all users, is reserved for displaying third-party applications. This third-party area is fluid, in that it may be resized. Sizing may be based on the size of the third-party application and its associated requirements.

An algorithm based on engagement level and popularity may be used to display the most popular third-party application as icons. The backend will track a user's engagement by the amount of actions associated with particular third-party application. A ranking coefficient based on the number of active application users may be used to determine which app will display in the front. Developer can also purchase the better placement for a charge or as a subscription service. Players can also report apps that contain spam or apps that are bad in any other way. Applications may also be sorted based on the app type category (e.g. virtual goods, poker related, etc . . . ).

The area for interaction under third party control is termed an ‘iframe’. Third-party applications may be loaded in the game as an HTML-iframe or similar technology in the future like a so called HTML-DIV or overlay. Applications in the poker room will typically be designed for a single player, and all players at the table may access the application individually as desired.

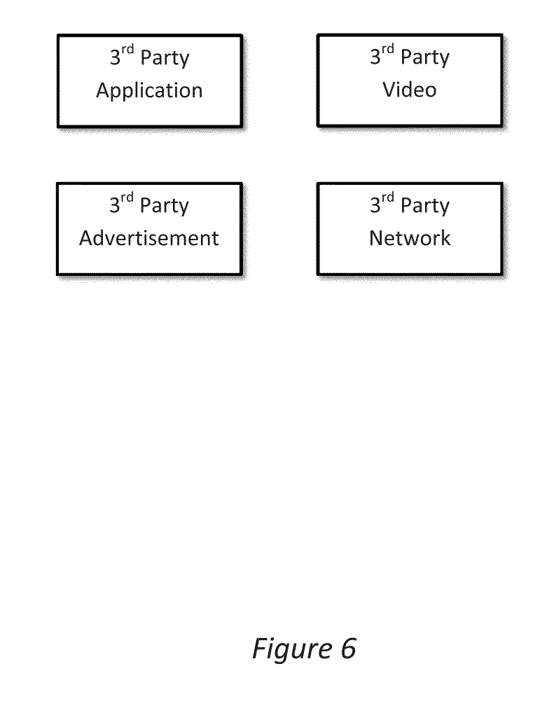

FIG. 6 is an exemplary illustration of using an iframe. As illustrated, the iframe may contain third-party applications, advertisements, videos and networks. The iframe creates an ecosystem of application developers and advertisers in the context of a game. This platform also allows application developers to enhance a game experience and promote interaction between players. Therefore, third-party developers increase the backend power.

The effect that third-party applications have on the host game performance can be controlled. The amount of bandwidth the third party uses to query the database may be limited, so that a poorly designed third party application will not affect the platform. The game platform may also assign a specific encrypted key and user's cookies for authentication.

Third-party applications may allow the use of a virtual instance (cloud) or any kind of framework. Third-party applications may cache methods for better performance. These independent third-party applications can interact with the host game if desired. The applications may be created with a front-end language (e.g. HTML5).

The application in an iframe can run from the internet domain of the developer. This means the developer can freely publish the content, which will be shown in the iframe in the game the user is playing. The application running in the iframe can communicate with the game through open standard backend communication (e.g. a JavaScript API or a JavaScript SDK). This open standard backend communication exposes a limited set of public functions that are related to the parent or host game. Examples can be, but are not limited to: information of the current player; historical information of the player in the game; messages from and to other players in this game; and current events that are happening in the game at the very moment (e.g. the two cards a player just got when he started a new round of poker). The JavaScript interface of the game will then, if needed, make connections to the backend servers of the game to save or load the requested information by the application in the iframe.

To receive event-based information from the game, the application in the iframe can subscribe (i.e. listen) to certain pre-defined events of the game. Examples are “player receives two cards,” “player finished a game,” “player goes all-in,” “player wins a poker-hand,” and “player loses a poker-hand.”

The developer of the application in the iframe is free to make direct requests to his own backend servers for loading or saving other data. This data can be completely different from what is used in the current game. An example could be that the application of the third party developer sends the current two cards of the player to his backend to analyze the strength of the cards. The result could be an advice to the player in the game to perform a certain action, in the case of poker this could be an advice to fold, check, raise or bet all money the player has ('all-in').

Another example could be a graph or chart based on historical collected data by the application in the iframe. The chart could show the results of the last 100 poker-hands played by the player and the average winning ratio. Other examples of third-party applications include:
1. Facebook feed display within the host game
2. P2P video conference while playing the host game
3. Poker tracking feature, e.g. rank a hand or evaluate an opponent's style
4. Sport game live streaming for bets
5. IP camera app
6. Pandora radio app
7. Interactive application for big brand or movies to advertise on the platform

Allowing a third party to develop applications and advertisements in a completely open platform may create a viral effect. Third parties may also market their development. The marketing effect may multiply. In order to control the quality of the application, the host reserves the rights to remove any applications or advertisements that cause negative user's experience. The amount of innovation and features can increase in a short period of time. The usefulness of the applications is determined by the players. The poor and useless applications will be eliminated based on the popularity.

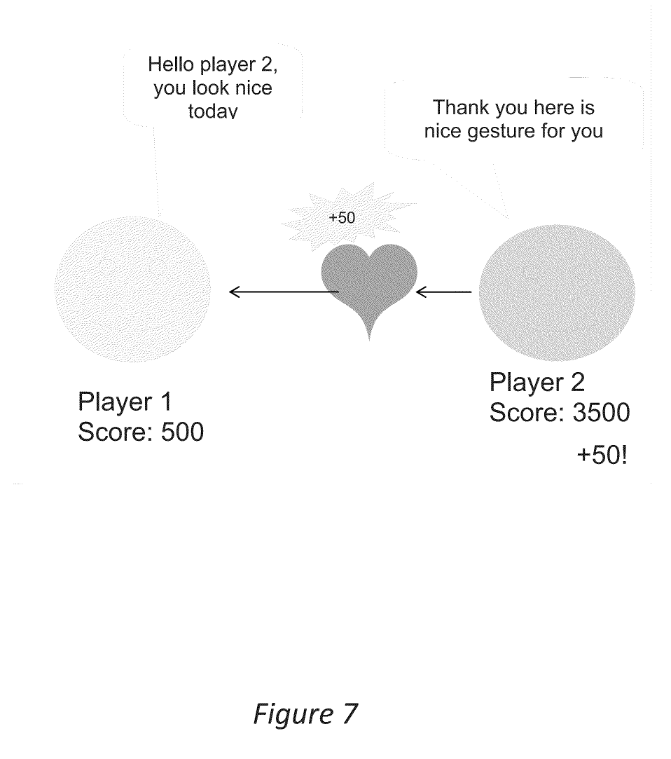

FIG. 7 is another exemplary illustration of using an iframe. Within the context of the dating game scenario, players may interact with each other. For example, player 1 sends a message—“Hello player 2, you look nice today.” Player 2 may respond—“Thank you here is nice gesture for you.” The response from player 2 may also include any additional multimedia display. For example, a heart can be sent. Interaction can be quantified and scored. Points may be redeemed for rewards such as poker chips.

The iframe also enables third-party development of specialized interaction applications. Within the context the dating game as the host application, third-party interaction applications may be designed for just two players.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A platform for a collaborative social network, wherein the platform comprises:
a database operable to store data associated with a plurality of social network members;
a host application server operable to access data from the database and control a multiplayer online poker game, wherein a display associated with the multiplayer online poker game comprises an area reserved for one or more third party applications; and
an application server operable to control the one or more third party applications and operable to access data from the database, wherein the rate at which the application server accesses data is controlled by the host application server.

2. The platform of claim 1, wherein the one or more third party applications comprise advertisements.

3. The platform of claim 1, wherein the one or more third party applications comprise a poker tracking feature.

4. A platform for a collaborative social network, wherein the platform comprises:
a database operable to store data associated with a plurality of social network members;
a host application server operable to access data from the database and control a dating game, wherein a display associated with the dating game comprises an area reserved for one or more third party applications; and
an application server operable to control the one or more third party applications and operable to access data from the database, wherein the rate at which the application server accesses data is controlled by the host application server.

5. The platform of claim 4, wherein the one or more third party applications comprise advertisements.

6. The platform of claim 4, wherein the one or more third party applications comprise a video display.

7. A platform for a collaborative social network, wherein the platform comprises:
a game server operable to maintain a direct connection with a client;
a web server operable to handle a non-real-time request from the client;
a database operable to store data;
a data queue server operable to communicate data;
a host application server operable to access data from the database and communicate data with the game server via the data queue; and
an application server operable to access data from the database and communicate data with the game server via the data queue, wherein the rate at which the application server is operable to access data is controlled by the host application server.

8. The platform of claim 7, wherein the application server operable to control one or more third party applications and operable to access data from the database, wherein the rate at which the application server accesses data is controlled by the host application server.

9. The platform of claim 7, wherein a display associated with a host application controlled by the host application server comprises an area reserved for one or more third party applications.

10. The platform of claim 7, wherein the host application server is operable to control a processing of data according to the rules of a game.

11. The platform of claim 10, wherein the game is poker and the host application server is operable to communicate data to the game server to enable a multimedia poker game at the client.

12. The platform of claim 7, wherein the host application server is operable to control a processing of data according to interactions among a plurality of virtual players in a relationship application.

13. The platform of claim 12, wherein the interactions among the plurality of virtual players in the relationship application result in an accumulation of virtual currency.

14. The platform of claim 7, wherein the non-real-time request from the game client is one or more of an image or a software program.

15. The platform of claim 7, wherein the application server is operable to load and save profiles, scores and inventories.

16. The platform of claim 7, wherein the client connects to the game server and the web server to play a game.

17. The platform of claim 7, wherein the request from the client for non-critical data is a pull-request.

18. The platform of claim 7, wherein the request from the client for non-critical data comprises a request for images.

19. The platform of claim 7, wherein the game server is a stateful socket-server.

20. The platform of claim 7, wherein the direct connection with the client is a live bi-directional connection.
